(19) United States
(12) Patent Application Publication
(10) Pub. No.: US 2023/0236659 A1
(43) Pub. Date: Jul. 27, 2023

(54) Systems and Methods For Providing A Delivery Assistance Service Having An Augmented-Reality Digital Companion

(71) Applicant: Ford Global Technologies, LLC, Dearborn, MI (US)

(72) Inventors: Jian Wan, Novi, MI (US); Harald Christian Martinez, Northville, MI (US); Kwaku Prakah-Asante, Commerce Twp., MI (US); Kenneth Michael Mayer, Ypsilanti, MI (US)

(73) Assignee: Ford Global Technologies, LLC, Dearborn, MI (US)

(21) Appl. No.: 17/648,915

(22) Filed: Jan. 25, 2022

(51) Int. Cl. G06F 3/01; G01C 21/36; G06Q 10/08; G06T 19/00

(52) U.S. Cl. CPC G06F 3/011; G01C 21/365; G01C 21/3697; G06Q 10/083; G06T 19/006

(57) ABSTRACT

The disclosure generally pertains to systems and methods for providing a delivery assistance service having an augmented-reality digital companion (ARDC). In an example method, a first set of instructions can be received via the ARDC. The first set of instructions can direct a delivery driver to an assigned delivery vehicle within a parking lot. A second set of instructions including a driving destination can be received via the ARDC. When the delivery driver has reached the driving destination, a third set of instructions can be received via the ARDC. The third set of instructions can include a route from the driving destination to a delivery location. When the delivery driver is traveling along the route, first pop-up information can be provided via the ARDC. The delivery request can be completed, and second pop-up information can be provided via the ARDC to assist the delivery driver in reaching an intended destination.

### BACKGROUND

Delivery drivers may have to undertake a series of steps in order to deliver a package from a warehouse to its destination. For example, a delivery driver may have to locate the assigned delivery vehicle for the day, drive to an area for the delivery, search for and access a package for delivery from a cargo area of the delivery vehicle, walk from a parking spot to the delivery location, manually update an inventory database that a delivery has been completed, and return to the vehicle to begin the next delivery. Thus, the delivery process may be inconvenient for delivery drivers and thus reduce their productivities.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example delivery assistance service having an augmented reality digital companion in accordance with an embodiment of the disclosure.

FIG. 2 illustrates an example implementation of a delivery assistance service having an augmented reality digital companion in accordance with an embodiment of the disclosure.

FIG. 3 illustrates an example implementation of a delivery assistance service having an augmented reality digital companion in accordance with an embodiment of the disclosure.

FIG. 4 illustrates an example implementation of a delivery assistance service having an augmented reality digital companion in accordance with an embodiment of the disclosure.

FIG. 5 depicts a flow chart of an example method for utilizing a delivery assistance service having an augmented reality digital companion in accordance with the disclosure.

FIG. 6 depicts a block diagram of an example machine upon which any of one or more techniques (e.g., methods) may be performed, in accordance with an embodiment of the disclosure.

### DETAILED DESCRIPTION

### Overview

In terms of a general overview, certain embodiments described in this disclosure are directed to systems and methods for providing a delivery assistance service having an augmented-reality digital companion. In an example method, a first set of instructions associated with a delivery request can be received via an augmented-reality digital companion. The first set of instructions can direct a delivery driver to an assigned delivery vehicle within a parking lot. A second set of instructions associated with the delivery request can then be received via the augmented-reality digital companion. The second set of instructions can comprise at least a driving destination. When the delivery driver associated with the delivery request has reached the driving destination, a third set of instructions associated with the delivery request can be received via the augmented-reality digital companion. The third set of instructions can comprise a route from the driving destination to a delivery location. When the delivery driver is traveling along the route, first pop-up information can be provided to the delivery driver via the augmented-reality digital companion. The delivery request can then be completed, and second pop-up information can be provided to the delivery driver via the augmented-reality digital companion. The second pop-up information can be configured to assist the delivery driver in reaching an intended destination of the delivery driver.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component.

Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the phrase “delivery driver” may be used interchangeably with the word “user” and the word “driver.” Either word as used herein refers to any individual that is utilizing the delivery assistance service. The word “device” may be any of various devices, such as, for example, a user device such as a smartphone or a tablet, a smart vehicle, and a computer.” The word “sensor” may be any of various sensors that can be found in a vehicle, such as cameras, radar sensors, Lidar sensors, and sound sensors.

It must also be understood that words such as “implementation,” “scenario,” “case,” and “situation” as used herein are an abbreviated version of the phrase “in an example (“implementation,” “scenario,” “case,” “approach,” and “situation”) in accordance with the disclosure.” Furthermore, the word “example” as used herein is intended to be non-exclusionary and non-limiting in nature.

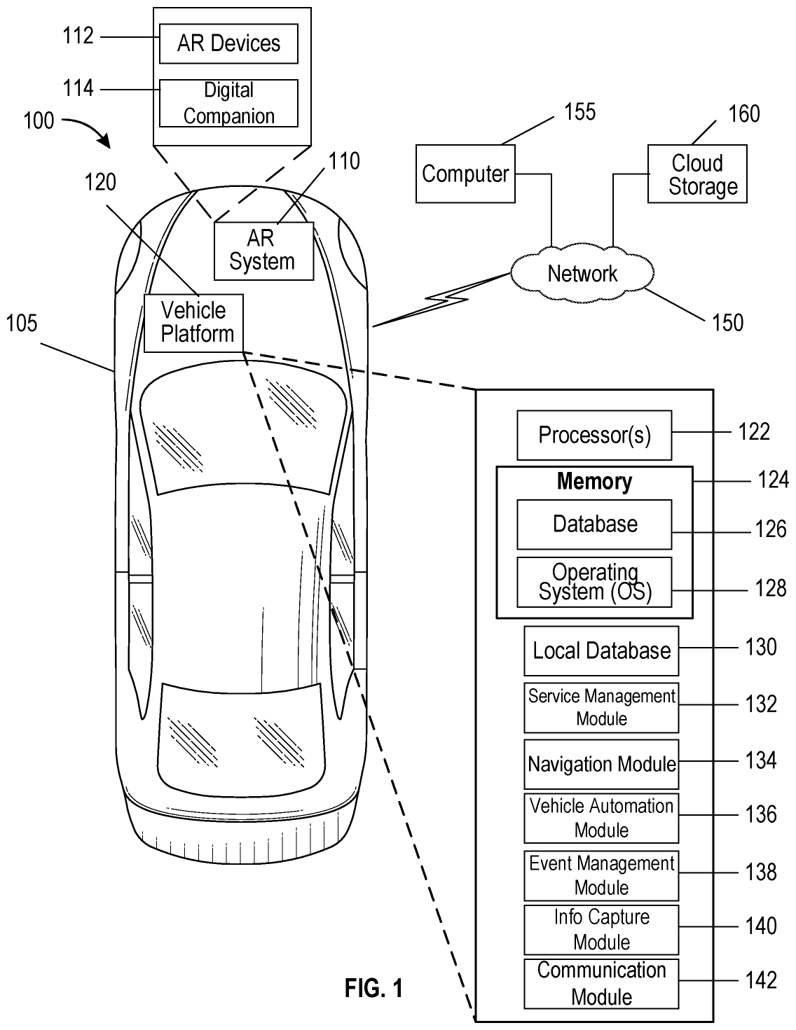

FIG. 1 illustrates an example delivery assistance service 100 in accordance with an embodiment of the disclosure. The delivery assistance service 100 may be carried out by a vehicle 105, which may be any of various types of vehicles such as, for example, a gasoline powered vehicle, an electric vehicle, a hybrid electric vehicle, an autonomous vehicle, a sedan, a van, a minivan, a sports utility vehicle, a truck, a station wagon, or a bus.

The vehicle 105 may further include components such as, for example, an augmented reality (AR) system 110 and a vehicle platform 120. The vehicle 105 may further include various types of sensors and detectors configured to provide various functionalities. In some embodiments, the AR system 110 may include additional components, such as AR device(s) 112 and/or a digital companion 114. In some embodiments, the AR system 110 may not be physically built into the vehicle 105, but may be wirelessly connected to the vehicle 105. In other embodiments, the AR system 110 may be detachable from the vehicle 105. In yet other embodiments, the AR system 110 may be built into the vehicle 105.

In some embodiments, the vehicle platform 120 may include a processor 122 and a memory 124. It must be understood that the memory 124 is a functional block that can be implemented in hardware, software, or a combination thereof. The processor 122 may carry out various operations by executing computer-readable instructions stored in the memory 124. The memory 124, which is one example of a non-transitory computer-readable medium, may be used to store a database 126 for storing data and an operating system (OS) 128.

In some embodiments, the vehicle platform 120 may be configured to include various components having functions associated with providing the delivery assistance service 100. For example, the vehicle platform 120 may include a local database 130, a service management module 132, a navigation module 134, a vehicle automation module 136, an event management module 138, an information capture module 140, and a communication module 142. In some embodiments, the various components of the vehicle platform 120 may be communicatively coupled to each other via wired and/or wireless connections. More particularly, the various components of the vehicle platform 120 may be communicatively coupled to the vehicle 105 via a vehicle bus that uses a controller area network (CAN) bus protocol, a Media Oriented Systems Transport (MOST) bus protocol, and/or a CAN flexible data (CAN-FD) bus protocol. In another embodiment, the communications may be provided via wireless technologies such as Bluetooth®, Ultra-Wideband (UWB), cellular, Wi-Fi, ZigBee®, or near-field communications (NFC).

In some embodiments, the AR system 110 and the vehicle platform 120 are configured to communicate via a network 150 with devices located outside the vehicle 105, such as, for example, a computer 155 (a server computer, a cloud computer, etc.) and/or a cloud storage device 160.

The network 150 may include any one, or a combination of networks, such as, for example, a local area network (LAN), a wide area network (WAN), a telephone network, a cellular network, a cable network, a wireless network, and/or private/public networks such as the Internet. The network 150 may support any of various communications technologies, such as, for example, TCP/IP, Bluetooth®, near-field communication (NFC), Wi-Fi, Wi-Fi Direct, Ultra-Wideband (UWB), cellular, machine-to-machine communication, and/or man-to-machine communication.

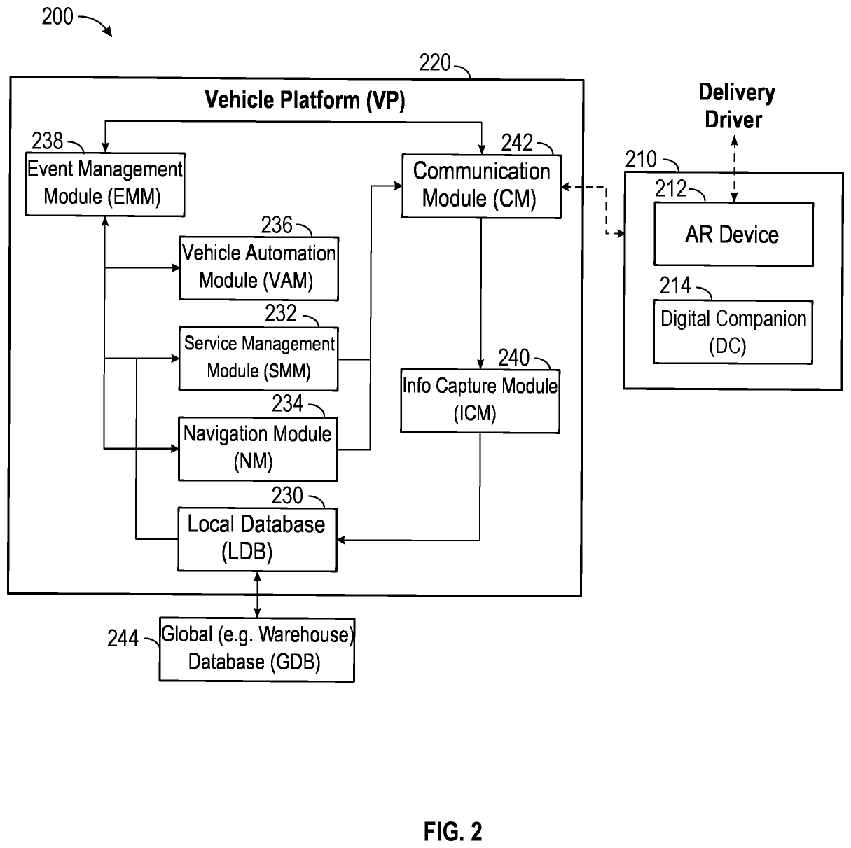

FIG. 2 illustrates an example implementation of a delivery assistance service 200 having an augmented-reality digital companion in accordance with an embodiment of the disclosure. The delivery assistance service 200 may be configured to use AR technologies to provide an interactive situation-based tool for a delivery driver to receive location-based and vehicle-based assistance during the delivery process. The delivery assistance service 200 may include an AR system 210 and a vehicle platform 220. For example, the AR system 210 may be the AR system 110 depicted in FIG. 1. In another example, the vehicle platform 220 may be the vehicle platform 120 depicted in FIG. 1. In some embodiments, the AR system 210 may include an AR device 212 and a digital companion 214. In some embodiments, the vehicle platform 220 may include a local database 230, a service management module 232, a navigation module 234, a vehicle automation module 236, an event management module 238, an information capture module 240, and a communication module 242. The local database 230 may be further connected to a global database 244, for example, a warehouse database or the database 126 depicted in FIG. 1.

In some embodiments, the local database 230 may communicate with the global database 244 to retrieve delivery-service-related data. The local database 230 may further send a delivery status, any lessons learned during the delivery, and/or an inventory status in a delivery vehicle to the global database 244 in order to update the global database 244 for example, the local database 230 may communicate with the global database 244 to update the global database 244 that a delivery is complete, that certain delivery instructions associated with a delivery address may have changed, and/or that a change has occurred in a delivery vehicle's inventory status. The global database 244 may store information based at least in part on a location associated with each piece of information. As a result, each local database 230 in each vehicle may only store and exchange information with the global database 244 associated with the vehicle's routes, present locations, and/or service domains. In some instances, the information may be locally stored at the vehicle, for example, the vehicle 105 depicted in FIG. 1, or the information may be stored in a locally partitioned cloud service, for example, the cloud storage device 160 depicted in FIG. 1. In some embodiments, the local database 230 provides information for communication between the vehicle, for example, the vehicle 105 depicted in FIG. 1, and a delivery driver. The local database 230 may be configured to provide input to the service management module 232 and the navigation module 234 by transmitting service-related data to the service management module 232 and delivery addresses to the navigation module 234. The local database 230 may also receive and store information associated with lessons learned and delivery statuses from the information capture module 240.

In some embodiments, the service management module 232 may be configured for several functions. The service management module 232 may be configured to manage a delivery assistance service in a singular trip by deciding a sequence of delivery for the packages in a delivery vehicle, which packages are delivered at a point in time, and where each package should be delivered. Additionally, the service management module 232 may be configured to retrieve service data from the local database 230 and then send the service data to the AR system 210 through the communication module 242. In further embodiments, the service management module 232 may be configured to retrieve lessons learned from the local database 230 related to the delivery assistance service 200 and then send the lesson data to the AR system 210 through the communication module 242.

In some embodiments, the navigation module 234 may be configured to retrieve address information associated with each package in the delivery vehicle. The navigation module 234 may be further configured to generate a navigation route for the delivery vehicle and a last-mile delivery route associated with each package in the delivery vehicle. The navigation module 234 may be additionally configured to retrieve lessons learned from the local database 230 that may be relevant to the last-mile delivery route associated with each package in the delivery vehicle.

In some embodiments, the vehicle automation module 236 may be configured to manage activities and/or functions associated with the delivery vehicle, such as locking and unlocking the vehicle. The vehicle automation module 236 may be triggered by events that are managed by the event management module 238.

In some embodiments, the event management module 238 may be configured to manage events associated with the AR system 210 and/or the delivery vehicle. Examples of events may include a delivery driver leaving or returning to the delivery vehicle, a vehicle door of the delivery vehicle opening or closing, a delivery driver arriving at a delivery location, or any other event associated with the delivery process. Such events may trigger vehicle actions through the vehicle automation module 236, update delivery statuses through the service management module 232, and/or generate or modify a navigation route and/or a last-mile delivery route through the navigation module 234. The event management module 238 may be configured to exchange information with the AR system 210 through the communication module 242.

In some embodiments, the information capture module 240 may be configured to receive feedback and lessons learned from the AR system 210 through the communication module 242. The information capture module 240 may be further configured to store the information, such as the feedback and the lessons learned, into the local database 230 for later use. In some embodiments, the communication module 242 may be the interface between the vehicle platform 220 and the AR system 210. The communication module 242 may thus be configured to send service-related data and navigation-related information to the AR system 210. The communication module 242 may be additionally configured to receive commands, feedback, and lessons learned from the AR system 210. The communication module 242 may exchange data with the AR system 210 through wireless communication methods.

When the engine of the delivery vehicle is off, the vehicle platform 220 may be kept awake or may be woken up to facilitate communication and/or interaction with the AR system 210 if the delivery driver is within a predetermined distance of the delivery vehicle or the vehicle platform 220 has received a request from the delivery driver. The waking up of the vehicle platform 220 may be performed through a cloud network.

In some embodiments, the AR system 210 may include at least one AR device 212. In other embodiments, multiple AR devices 212 may be included. The AR device(s) 212 may include AR glasses, a handheld AR device, or any other suitable AR device. The AR system 210 may be configured to communicate with the vehicle platform 220 through the communication module 242.

In some embodiments, the AR system 210 may receive a variety of data from the vehicle platform 220, including service information and navigation information. Service information may include a package that is being identified for delivery. Navigation information may include a route to the delivery location. The AR system 210 may receive other types of data, including instructions and/or commands for remote assistance from the delivery vehicle or a warehouse from which the delivery vehicle began its delivery routes, shared lessons learned from previous deliveries, and/or pop-up situations such as road construction or ongoing floods. Pop-up situations may be communicated to the AR system 210 as a result of notifications provided by other delivery drivers.

In some embodiments, the AR system 210 may be configured to transmit a variety of data to the vehicle platform 220. For example, the AR system 210 may transmit a current location of the AR device 212, commands from the delivery driver provided to the AR device 212, lessons learned during the delivery process, updates to lessons previously learned during the delivery process, updates to a previously-detected pop-up situation, and/or an attached timestamp associated with each event captured by the AR device 212. The commands from the delivery driver may include voice commands, gesture commands, or any other instruction provided to the AR device 212. As an example, updates to a previously-detected pop-up situation may include a notification that road construction in an area has been completed, or a notification that a flooding situation in an area has improved recently. In some instances, the attached timestamp may refer to a season, a time frame, or another suitable period of time. For example, the attached timestamp may note that a road tends to be slippery during the winter, or that road construction may be ongoing for a predetermined period of time.

In some embodiments, the AR device(s) 212 may generate a holographic companion 214 (also known as the digital companion 214) and display the holographic companion adjacent to the delivery driver who is using the AR device(s) 212. In some instances, the holographic companion 214 may provide a variety of benefits, such as visually leading a delivery driver to locate the assigned delivery vehicle in the parking lot, indicating a preferred walking direction towards the delivery location once the delivery vehicle has reached a driving destination by leveraging previously-learned lessons associated with the delivery route. In some embodiments, the walking direction may be optimized. The holographic companion 214 may be further configured to provide instructions to the delivery driver based on previously-learned lessons and/or pop-up situations in an engaging manner. The AR device(s) 212 may also be configured to collect information from the delivery driver during the delivery process. This information may include new lessons learned from the current delivery process, such as waypoints along a new route inside a building that is not presently stored in the global database 244, an update to previously-learned lessons or pop-up situations, such as route changes, added situations, or removed situations, and/or commands used to trigger vehicle automation. Other information provided to the AR device(s) 212 by the delivery driver may additionally be collected.

The AR device(s) 212 may further provide timely relevant information to the delivery driver based on data received from the vehicle platform 220, such as road construction and/or flooding. The holographic companion 214 may appear to and interact with the delivery driver in varying manners based at least in part on a present location of the delivery driver and a situation that the delivery driver is in. For example, the holographic companion 214 may only appear when the delivery driver is navigating a delivery route, or the holographic companion 214 may only appear on demand. The holographic companion 214 may further provide different pieces of information to the delivery driver at different stages of the delivery route. In one instance, the holographic companion 214 may appear closer to the delivery driver when the delivery driver is in a busy street, but the holographic companion 214 may appear farther from the delivery driver when the delivery driver has a clear view.

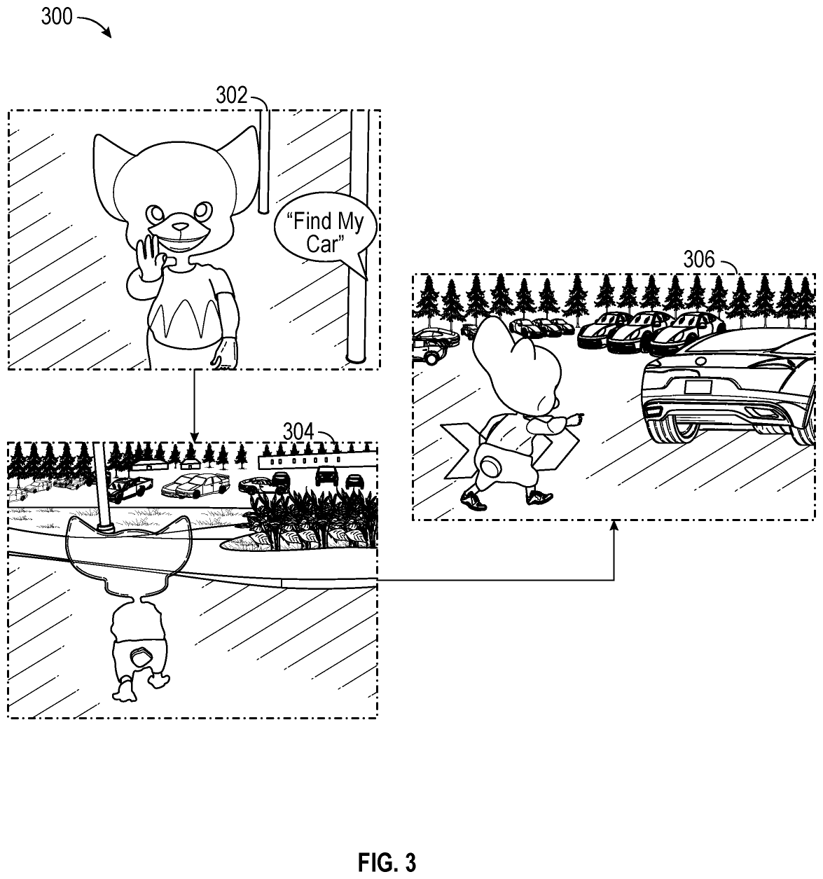

FIG. 3 illustrates an example implementation of a delivery assistance service 300 having an augmented reality digital companion in accordance with an embodiment of the disclosure.

In some instances, the process of delivering a package from a warehouse to a destination may be complicated by inconvenient steps. For example, an assigned delivery vehicle may be parked in a large parking lot with similar-looking delivery vehicles. As a result, it may be more difficult for a delivery driver to locate the assigned delivery vehicle quickly. In another example, a road along the delivery route may include complications, such as busy streets and pop-up situations like road construction and/or flooding, and may include indoor room searching within a building. The delivery process may also be more complicated if the delivery driver is not familiar with the area surrounding the delivery location.

In addition, the delivery driver may have to prepare the vehicle before engaging in last-mile delivery. For example, the delivery driver may have to roll up the vehicle windows and lock the vehicle door when the delivery driver leaves the vehicle, and the delivery driver may have to unlock the vehicle door when returning to the vehicle. Further, the delivery driver may need to obtain information associated with the package to be delivered prior to delivery. When a delivery has been completed, the delivery driver may subsequently need to update an inventory database to mark the delivery as complete and locate a package for the next delivery.

As depicted in FIG. 3, at block 302, a delivery driver may put on an AR device, such as AR device 212 depicted in FIG. 2, which may display a holographic companion. The holographic companion may begin to lead the delivery driver to the assigned delivery vehicle. At block 304, the holographic companion provides directions to instruct the delivery driver to travel towards a parking lot. At block 306, the holographic companion provides instructions within the parking lot to direct the delivery driver to the assigned delivery vehicle for the day. Although not depicted in FIG. 3, the holographic companion may further introduce a list of tasks for the delivery driver for that day and provide relevant information for the delivery driver to reach the first delivery location.

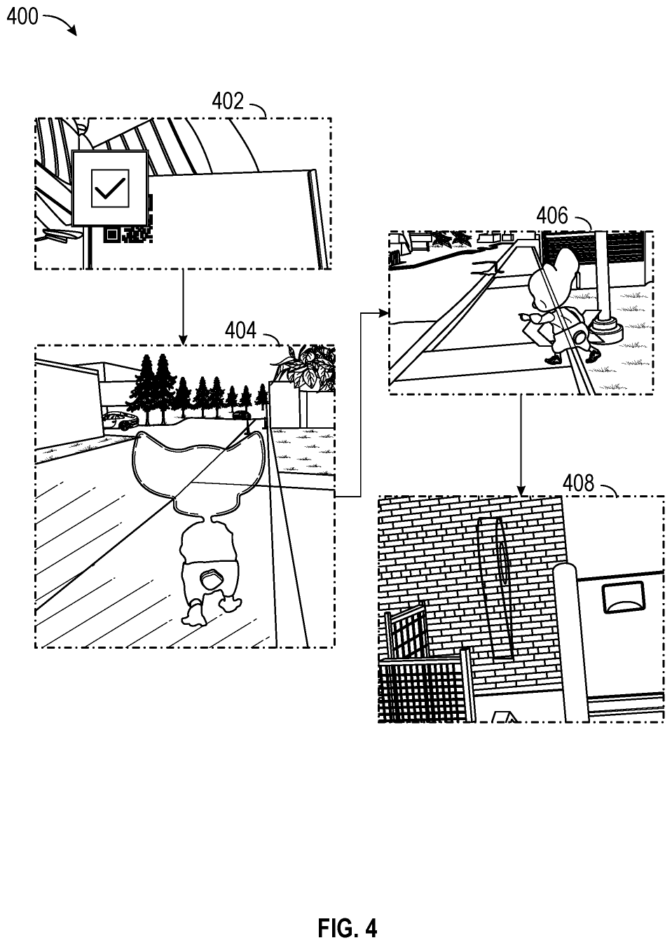

FIG. 4 illustrates an example implementation of a delivery assistance service 400 having an augmented reality digital companion in accordance with an embodiment of the disclosure.

Although not depicted in FIG. 4, when a delivery driver reaches a driving destination, a holographic companion may reappear and assist the delivery driver in locating the package associated with this delivery location. At block 402, when the delivery driver has located the package for delivery, the holographic companion may initiate showing a route to the delivery location and the delivery driver may begin the last-mile delivery route. The route may be retrieved from the local database. At this point, the delivery driver may request assistance to lock the delivery vehicle or perform another vehicle automation before proceeding on the last-mile delivery route. At block 404, the holographic companion proceeds to illustrate the path that the delivery driver should take in order to reach the delivery location. The holographic companion may keep a distance to the delivery driver such that the holographic companion does not block the delivery driver's view of the environment. In contrast, the holographic companion may keep closer to the delivery driver if the area is crowded. If the delivery driver deviates from the holographic companion's illustrated route, the holographic companion may guide the delivery driver back to the path through verbal directions and/or gestures.

For example, at block 406, the delivery driver may be guided to make a left turn at the holographic companion's instruction. In some instances, delivery instructions may only be provided to the delivery driver when the AR device detects that the delivery driver has arrived at a GPS location associated with the delivery address. Other instructions along the delivery process may be further provided as the delivery driver approaches a location necessitating those instructions. At block 408, the delivery driver may be notified that they have reached the appropriate building for delivery.

When the delivery driver is traveling along the last-mile delivery route, the holographic companion may provide lessons learned from previous delivery trips. For example, the holographic companion may inform the delivery driver of which entrance the delivery driver should go through, contact information for the delivery, a special process at an address, or other applicable delivery information. If the delivery driver discovers that the lessons learned have since changed, new and/or updated information may be collected and sent back to the vehicle. As an example, a change in recipient at the delivery address may result in the contact information for deliveries at this address being transmitted back to the vehicle and updated in the local and global databases. When the delivery driver reaches a delivery address that requires package drop-off at a room located inside a building, the delivery driver may be unfamiliar with how to locate the applicable room within the building if the delivery driver has never made a delivery in that building and there is no other information about the room stored in the local and/or global databases. In such an instance, the delivery driver may ask people located inside the building for directions or independently search the building for the room. The AR device may then record waypoints along the new path for transmission to the vehicle platform, and the holographic companion may further record any verbal notes provided by the delivery driver.

Upon successful delivery of a package, the holographic companion may send a delivery confirmation notification to the vehicle platform. The holographic companion may confirm with the delivery driver if the delivery driver intends on returning to the vehicle or otherwise. In one example, if the delivery driver intends on returning to the vehicle, the holographic companion may begin to provide route instructions to return to the vehicle. In another example, if the delivery driver intends on taking a break to have lunch, the holographic companion may wait for the delivery driver to have lunch before providing route instructions to return to the vehicle. If yet another example, if the delivery driver intends on taking a break to have lunch, the holographic companion may assist the delivery driver in reaching a lunch destination. In some embodiments, as the delivery driver approaches the vehicle, the holographic companion may assist in providing the vehicle platform with instructions to prepare the delivery vehicle. For example, the holographic companion may instruct the vehicle platform to unlock the delivery vehicle. When the delivery driver reaches the delivery vehicle, the holographic companion may then introduce the next package for delivery.

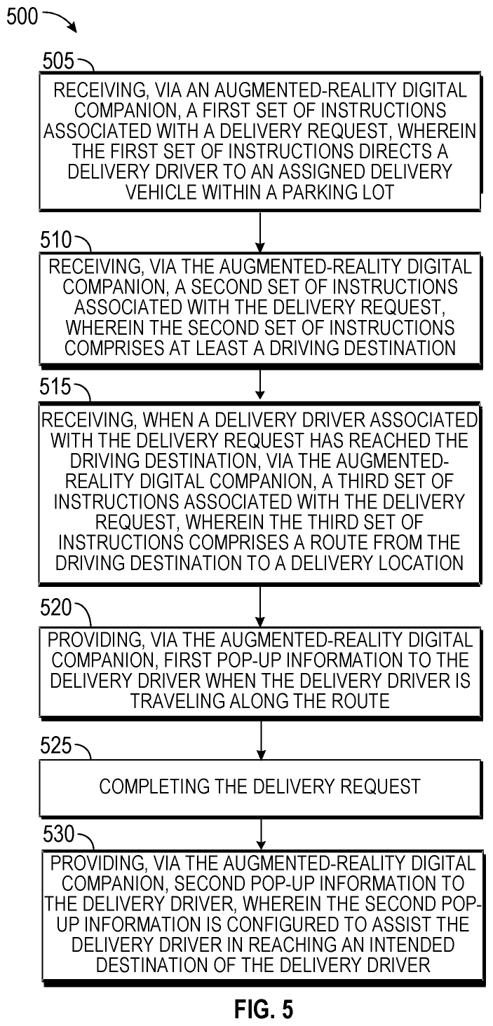

FIG. 5 shows a flow chart 500 of an example method of utilizing a delivery assistance service having an augmented reality digital companion in accordance with the disclosure. The flow chart 500 illustrates a sequence of operations that can be implemented in hardware, software, or a combination thereof. In the context of software, the operations represent computer-executable instructions stored on one or more non-transitory computer-readable media such as a memory 124 provided in the augmented reality system 110 and/or the vehicle platform 120, that, when executed by one or more processors such as the processor 122 provided in the augmented reality system 110 and/or the vehicle platform 120, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the flow chart 500 may be carried out by the augmented reality system 110 and/or the vehicle platform 120 either independently or in cooperation with other devices such as, for example, other components of the vehicle 105 and cloud elements (such as, for example, the computer 155 and cloud storage 160.

At block 505, a first set of instructions associated with a delivery request may be received via an augmented-reality digital companion. In some embodiments, the first set of instructions may direct a delivery driver to an assigned delivery vehicle within a parking lot. In some embodiments, the augmented-reality digital companion may be disposed within a pair of augmented-reality glasses, a handheld augmented-reality device, or another augmented-reality device.

At block 510, a second set of instructions associated with the delivery request may be received via the augmented-reality digital companion. In some embodiments, the second set of instructions may include a driving destination.

At block 515, a third set of instructions associated with the delivery request may be received via the augmented-reality digital companion. In some embodiments, the third set of instructions may only be received when the delivery driver has reached the driving destination. In some embodiments, the third set of instructions may comprise a route from the driving destination to a delivery location.

At block 520, first pop-up information may be provided to the delivery driver via the augmented-reality digital companion when the delivery driver is traveling along the route. In some embodiments, the augmented-reality digital companion may be configured to assist in locking the assigned delivery vehicle when the delivery driver is beginning to travel along the route. In some embodiments, the first pop-up information may comprise at least one of directions from the driving destination to the delivery location, an entrance to be used for completing the delivery request, contact information associated with the delivery request, or delivery notes associated with the delivery request. In some embodiments, the first pop-up information may be retrieved from a vehicle database. In some embodiments, the third set of instructions may further comprise the identification of a package associated with the delivery request out of at least one package disposed within the assigned delivery vehicle.

At block 525, the delivery request may be completed.

At block 530, second pop-up information may be provided to the delivery driver via the augmented-reality digital companion. In some embodiments, the second pop-up information may be configured to assist the delivery driver in reaching an intended destination of the delivery driver. In some embodiments, the intended destination of the delivery driver may be the assigned delivery vehicle or a geographic location.

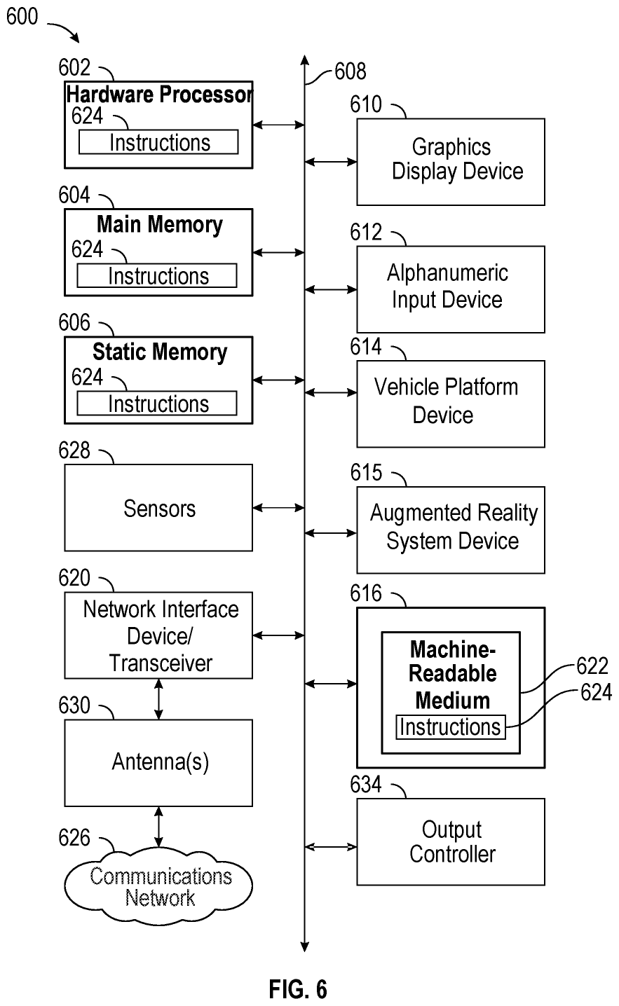

FIG. 6 depicts a block diagram of an example machine 600 upon which any of one or more techniques (e.g., methods) may be performed, in accordance with one or more example embodiments of the present disclosure. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environments. The machine 600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. In some embodiments, the machine 600 may be the vehicle 105, as depicted in FIG. 1. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a graphics display device 610, an alphanumeric input device 612 (e.g., a keyboard), a vehicle platform device 614, and an augmented reality system device 615. In an example, the graphics display device 610, the alphanumeric input device 612, the vehicle platform device 614, and the augmented reality system device 615 may be a touch screen display. The machine 600 may additionally include a storage device (i.e., drive unit) 616, a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee®, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, such as the processor 122, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device, such as the memory 124, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey the information that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving, via an augmented-reality digital companion, a first set of instructions associated with a delivery request, wherein the first set of instructions directs a delivery driver to an assigned delivery vehicle within a parking lot;
receiving, via the augmented-reality digital companion, a second set of instructions associated with the delivery request, wherein the second set of instructions comprises at least a driving destination;
receiving, when the delivery driver associated with the delivery request has reached the driving destination, via the augmented-reality digital companion, a third set of instructions associated with the delivery request, wherein the third set of instructions comprises a route from the driving destination to a delivery location;
providing, via the augmented-reality digital companion, first pop-up information to the delivery driver when the delivery driver is traveling along the route;
completing the delivery request; and
providing, via the augmented-reality digital companion, second pop-up information to the delivery driver, wherein the second pop-up information is configured to assist the delivery driver in reaching an intended destination of the delivery driver.

2. The method of claim 1, wherein the augmented-reality digital companion is disposed within a pair of augmented-reality glasses or a handheld augmented-reality device.

3. The method of claim 1, wherein the augmented-reality digital companion is configured to assist in locking the assigned delivery vehicle when the delivery driver begins to travel along the route.

4. The method of claim 1, wherein the first pop-up information comprises at least one of: directions from the driving destination to the delivery location, an entrance to be used for completing the delivery request, contact information associated with the delivery request, or delivery notes associated with the delivery request.

5. The method of claim 4, wherein the first pop-up information is retrieved from a vehicle database.

6. The method of claim 1, wherein the third set of instructions further comprises identifying a package associated with the delivery request out of at least one package disposed within the assigned delivery vehicle.

7. The method of claim 1, wherein the intended destination of the delivery driver comprises the assigned delivery vehicle or a geographic location.

8. A device, comprising:
at least one memory device that stores computer-executable instructions; and
at least one processor configured to access the at least one memory device, wherein the at least one processor is configured to execute the computer-executable instructions to:
receive, via an augmented-reality digital companion, a first set of instructions associated with a delivery request, wherein the first set of instructions directs a delivery driver to an assigned delivery vehicle within a parking lot;
receive, via the augmented-reality digital companion, a second set of instructions associated with the delivery request, wherein the second set of instructions comprises at least a driving destination;
receive, when the delivery driver associated with the delivery request has reached the driving destination, via the augmented-reality digital companion, a third set of instructions associated with the delivery request, wherein the third set of instructions comprises a route from the driving destination to a delivery location;
provide, via the augmented-reality digital companion, first pop-up information to the delivery driver when the delivery driver is traveling along the route;
complete the delivery request; and
provide, via the augmented-reality digital companion, second pop-up information to the delivery driver, wherein the second pop-up information is configured to assist the delivery driver in reaching an intended destination of the delivery driver.

9. The device of claim 8, wherein the augmented-reality digital companion is disposed within a pair of augmented-reality glasses or a handheld augmented-reality device.

10. The device of claim 8, wherein the augmented-reality digital companion is configured to assist in locking the assigned delivery vehicle when the delivery driver begins to travel along the route.

11. The device of claim 8, wherein the first pop-up information comprises at least one of: directions from the driving destination to the delivery location, an entrance to be used for completing the delivery request, contact information associated with the delivery request, or delivery notes associated with the delivery request.

12. The device of claim 11, wherein the first pop-up information is retrieved from a vehicle database.

13. The device of claim 8, wherein the third set of instructions further comprises identifying a package associated with the delivery request out of at least one package disposed within the assigned delivery vehicle.

14. The device of claim 8, wherein the intended destination of the delivery driver comprises the assigned delivery vehicle or a geographic location.

15. A non-transitory computer-readable medium storing computer-executable instructions which, when executed by a processor, cause the processor to perform operations comprising:
receiving, via an augmented-reality digital companion, a first set of instructions associated with a delivery request, wherein the first set of instructions directs a delivery driver to an assigned delivery vehicle within a parking lot;
receiving, via the augmented-reality digital companion, a second set of instructions associated with the delivery request, wherein the second set of instructions comprises at least a driving destination;
receiving, when the delivery driver associated with the delivery request has reached the driving destination, via the augmented-reality digital companion, a third set of instructions associated with the delivery request, wherein the third set of instructions comprises a route from the driving destination to a delivery location;
providing, via the augmented-reality digital companion, first pop-up information to the delivery driver when the delivery driver is traveling along the route;
completing the delivery request; and
providing, via the augmented-reality digital companion, second pop-up information to the delivery driver, wherein the second pop-up information is configured to assist the delivery driver in reaching an intended destination of the delivery driver.

16. The non-transitory computer-readable medium of claim 15, wherein the augmented-reality digital companion is disposed within a pair of augmented-reality glasses or a handheld augmented-reality device.

17. The non-transitory computer-readable medium of claim 15, wherein the augmented-reality digital companion is configured to assist in locking the assigned delivery vehicle when the delivery driver begins to travel along the route.

18. The non-transitory computer-readable medium of claim 15, wherein the first pop-up information comprises at least one of: directions from the driving destination to the delivery location, an entrance to be used for completing the delivery request, contact information associated with the delivery request, or delivery notes associated with the delivery request.

19. The non-transitory computer-readable medium of claim 18, wherein the first pop-up information is retrieved from a vehicle database.

20. The non-transitory computer-readable medium of claim 15, wherein the third set of instructions further comprises identifying a package associated with the delivery request out of at least one package disposed within the assigned delivery vehicle.
